(19) United States
(12) Patent Application Publication
(10) Pub. No.: US 2016/0165815 A1
(43) Pub. Date: Jun. 16, 2016

(54) TREE ANCHORING APPARATUS, KIT AND METHOD

(71) Applicant: PLATIPUS ANCHORS HOLDINGS LIMITED, Redhill, Survey (GB)

(72) Inventors: Charles Simon James AGG, Surrey (GB); Michael Hamilton RUSSELL, Burgess Hill (GB)

(73) Assignee: Platipus Anchors Holding Ltd.

(21) Appl. No.: 14/436,546

(22) PCT Filed: Oct. 15, 2013
(86) PCT No.: PCT/GB2013/052683

§ 371 Date: Apr. 17, 2015

(30) Foreign Application Priority Data
Oct. 17, 2012 (GB) 1218653.2

(51) Int. Cl. A01G 23/04

(52) U.S. Cl. CPC A01G 23/043

(57) ABSTRACT

Tree anchoring apparatus has a plurality of interlocking anchor units with each anchor unit having connection means that allow the anchor unit to be secured to at least one adjacent anchor unit, an anchoring point provided for each anchor unit, and a cable or strap securable to at least one of the anchoring points. The plurality of interlocking anchor units are transportable disengaged from one another and can be interlocked with each other in situ to jointly provide a surface for supporting an overburden of soil. The cable or strap can be used to secure the interlocked anchor units to a root ball of a tree located there above.

The present invention relates to tree anchoring apparatus, a tree anchoring kit and a method of anchoring of a tree.

The apparatus, kit and method of the invention are of particular use in anchoring a tree in shallow soil as part of a rooftop garden or use on a brownfield site and in urban environments, as will be further explained below.

When planting mature or semi-mature trees on rooftop gardens (or in brownfield sites or in urban environments, as described below), only shallow soil is available in which to locate the root ball of the trees. As such the tree requires support in addition to that of the weight of the soil upon the root ball to prevent it from falling over, e.g. when subject to wind loading. It is not permitted to anchor the root ball in any way that would penetrate the rooftop, since this comprises a water impermeable layer for protecting the inside of the building from water damage; this is also relevant for brownfield sites and for urban sites, as described below.

Similar restrictions occur on brownfield sites, which typically have an impermeable (gas tight) membrane separating the deep spoiled soil from the shallow upper layer of good soil. It is not permitted to penetrate such impermeable layers. Furthermore there may be services such as water pipes, gas pipes or electricity cables located below a barrier layer such as the impermeable membrane and the roots of the tree are to be prevented from reaching such services.

Therefore, when mature or semi-mature trees are transplanted to shallow ground, they are conventionally secured upright in their transplanted locations by firstly arranging weights, typically railway sleepers, kerb stones or path edging, below or around the intended location of the root ball of the tree and then tying to the weights a cable that is wrapped around the root ball. The mass of the weights is used to anchor the root ball.

Weights such as kerb stones, path edging or railways sleepers may be expensive, hard to store and transport, restrict the space available for the planting of trees, and increase the time taken to plant the trees. For roof top planting it is particularly inconvenient to transport heavy weights up to the top of a roof.

There is a need for a quick and cost effective method for anchoring a tree in shallow ground and cheap and lightweight apparatus that can be easily stored and transported.

A first aspect of the invention provides tree anchoring apparatus as defined by claim 1.

The invention provides in second and third aspects tree anchoring kits as defined by claims 14 and 15.

A fourth aspect of the invention provides a method of anchoring a tree as defined by claim 16.

A fifth aspect of the present invention provides a tree anchoring apparatus as claimed in claim 21 and a kit comprising said apparatus as claimed in claim 28.

Preferred examples of apparatus and methods according to the present invention will now be described with reference to the accompanying drawings in which:

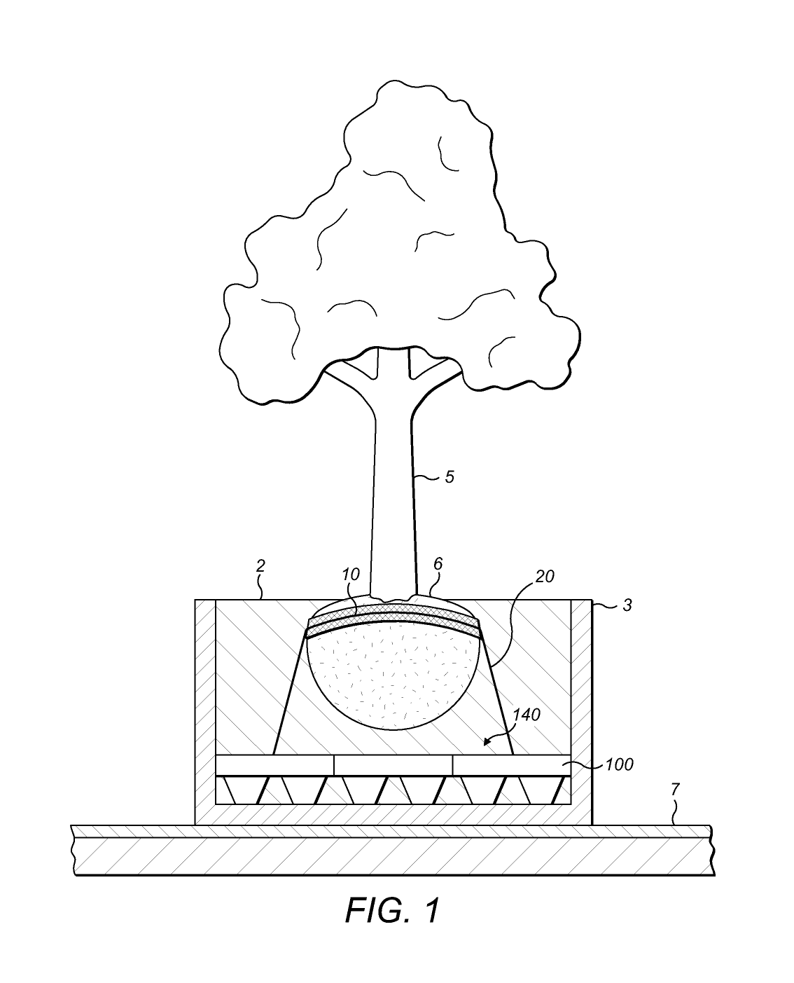

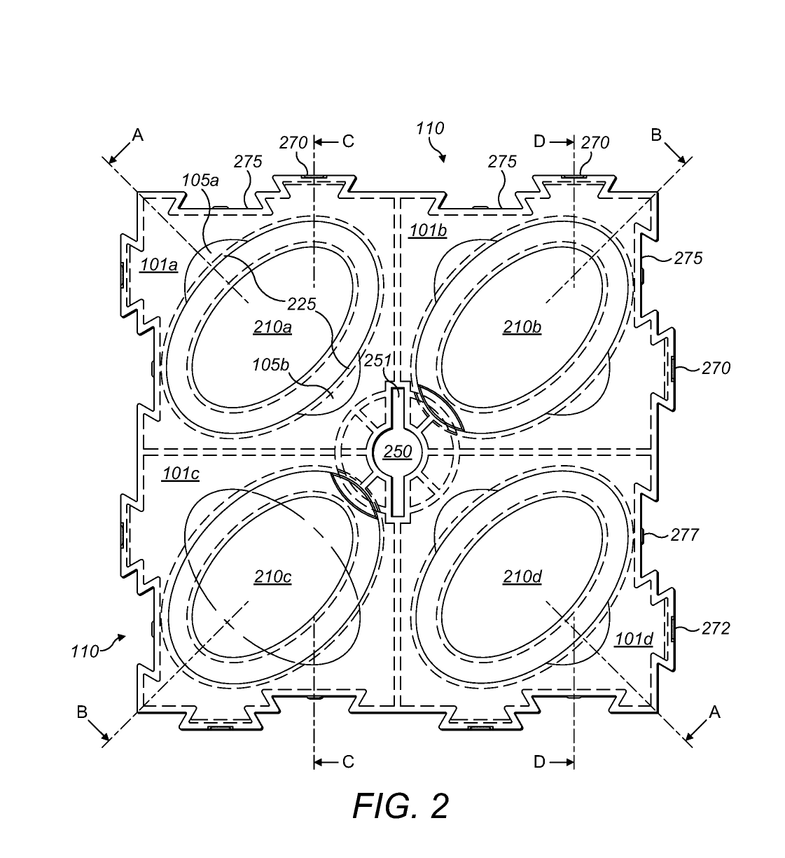

FIG. 1 is a diagram of a tree anchored by anchoring apparatus comprising anchor units as illustrated in FIGS. 2 to 9 arranged in a first arrangement;

FIG. 2 is a plan top view of an anchor unit of the first embodiment of tree anchoring apparatus illustrated in FIG. 1;

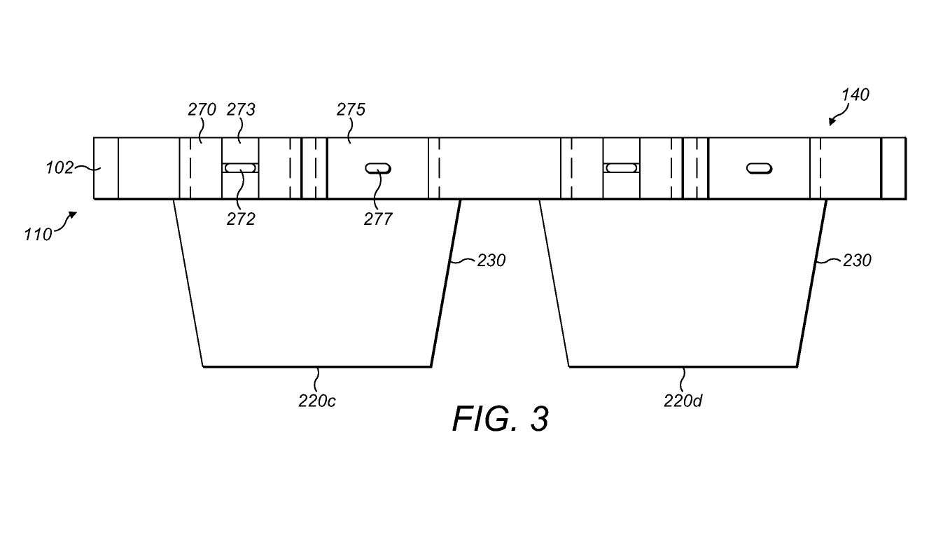

FIG. 3 is a side view of the anchor unit of FIG. 2;

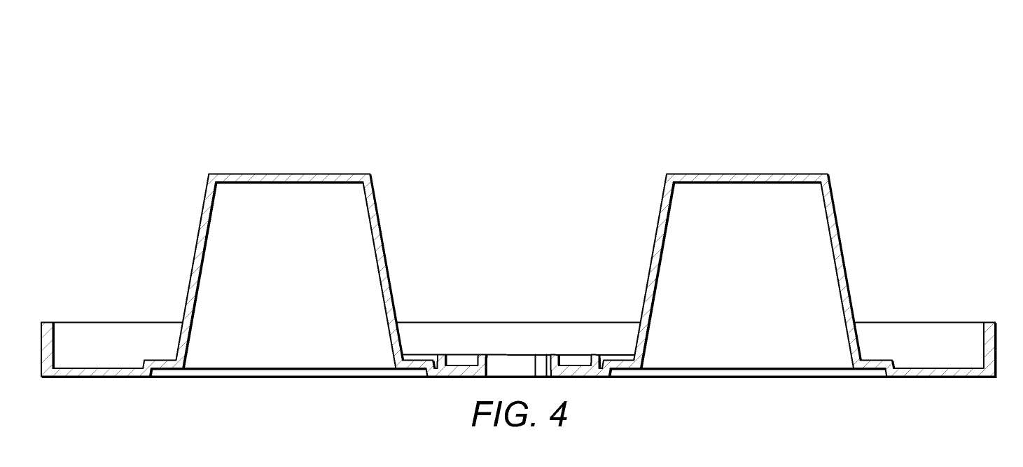

FIG. 4 is a cross-section through the anchor unit of FIG. 2, taken along the line A-A of FIG. 2;

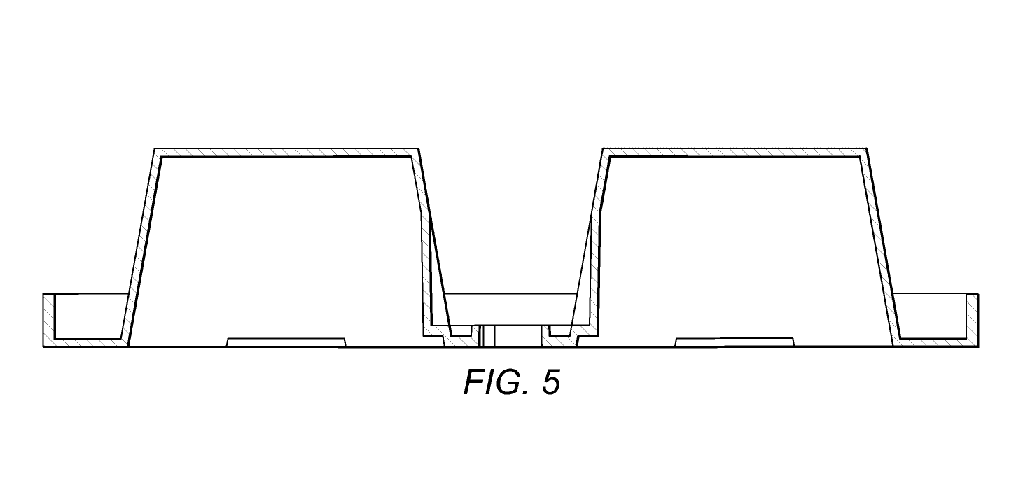

FIG. 5 is a cross-section through the anchor unit of FIG. 2; taken along the line B-B of FIG. 2;

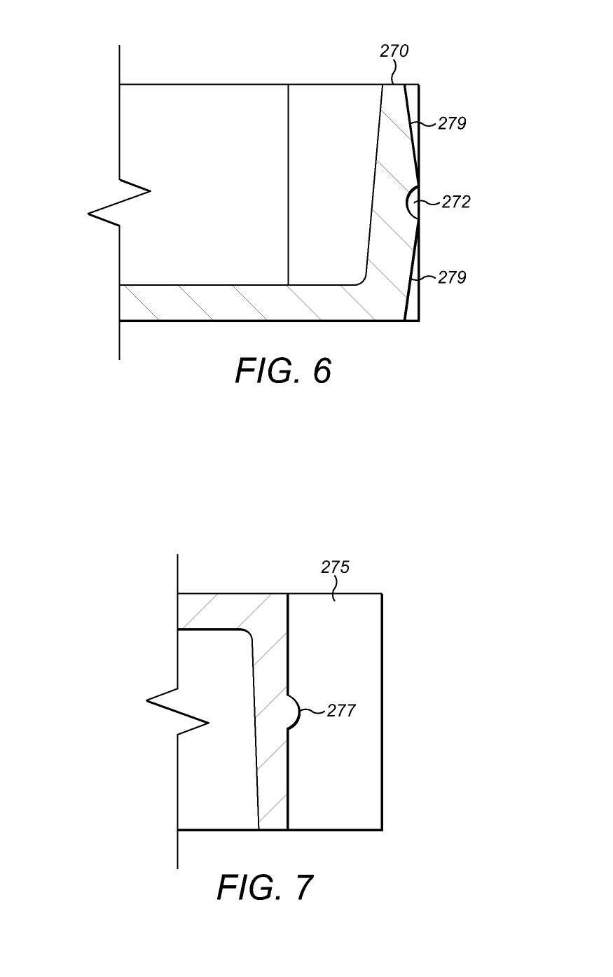

FIG. 6 is a detail view of a first part of the anchor unit of FIG. 2;

FIG. 7 is a detail view of a second part of the anchor unit of FIG. 3;

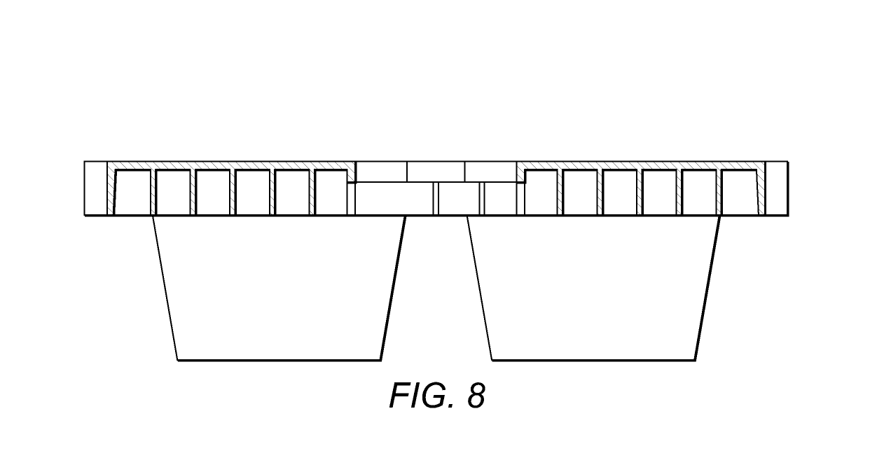

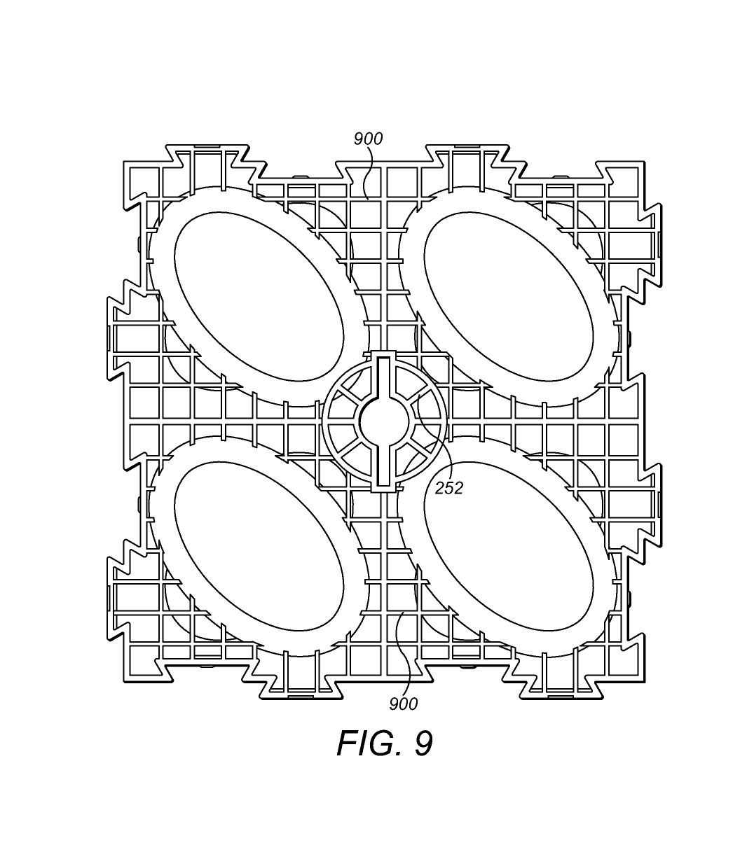

FIG. 8 is a cross-section along the line CL-CL of FIGS. 2 and 9;

FIG. 9 is an underneath plan view of the anchor unit of FIG. 2;

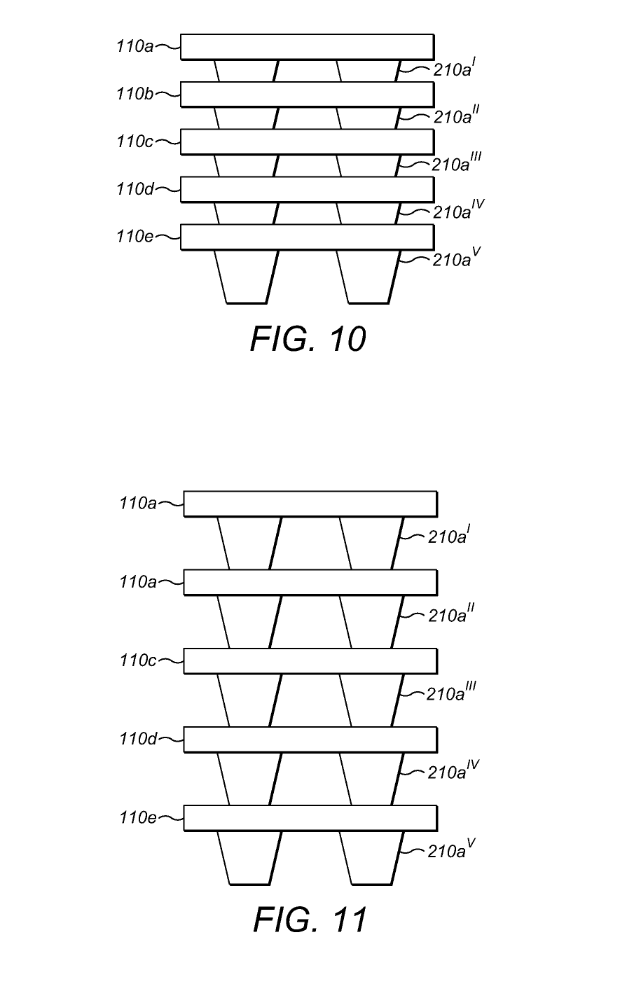

FIG. 10 is a schematic view of a first stacked arrangement of the anchor units of FIGS. 2 to 9;

FIG. 11 is a schematic view of a second stacked arrangement of the anchor units of FIGS. 2 to 9;

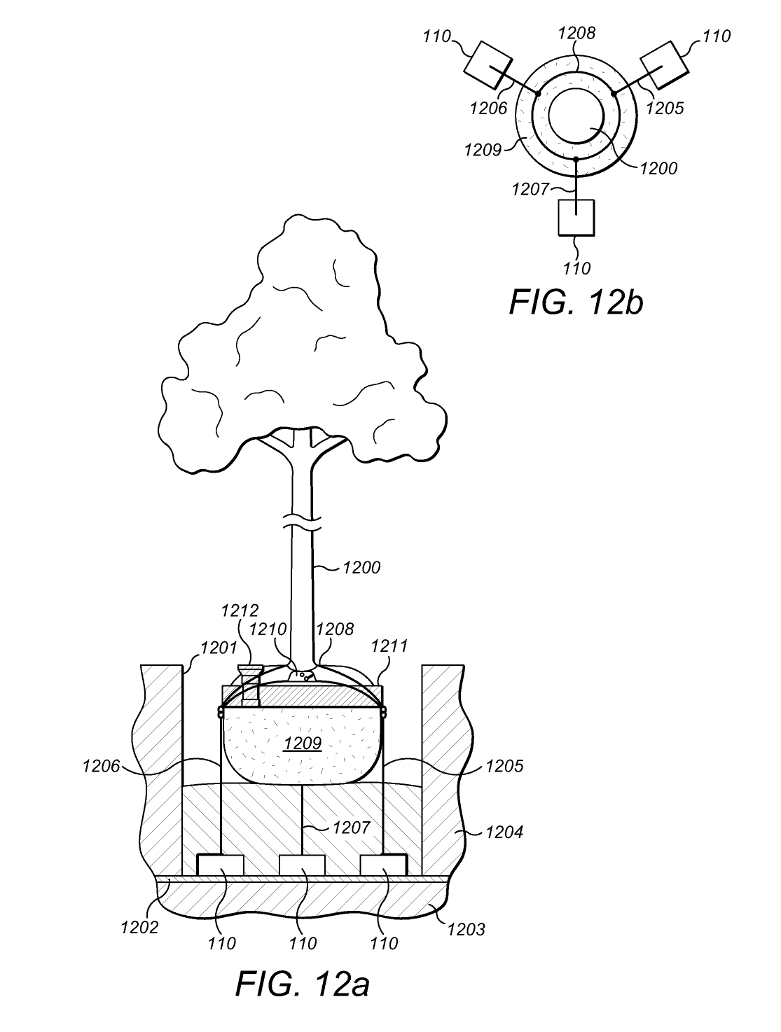

FIG. 12a is a schematic side view in part cross-section of a tree anchored by anchoring apparatus comprising anchor units as illustrated in FIGS. 2 to 11 arranged in a second arrangement and FIG. 12b is a schematic top plan view of the second arrangement of anchor units;

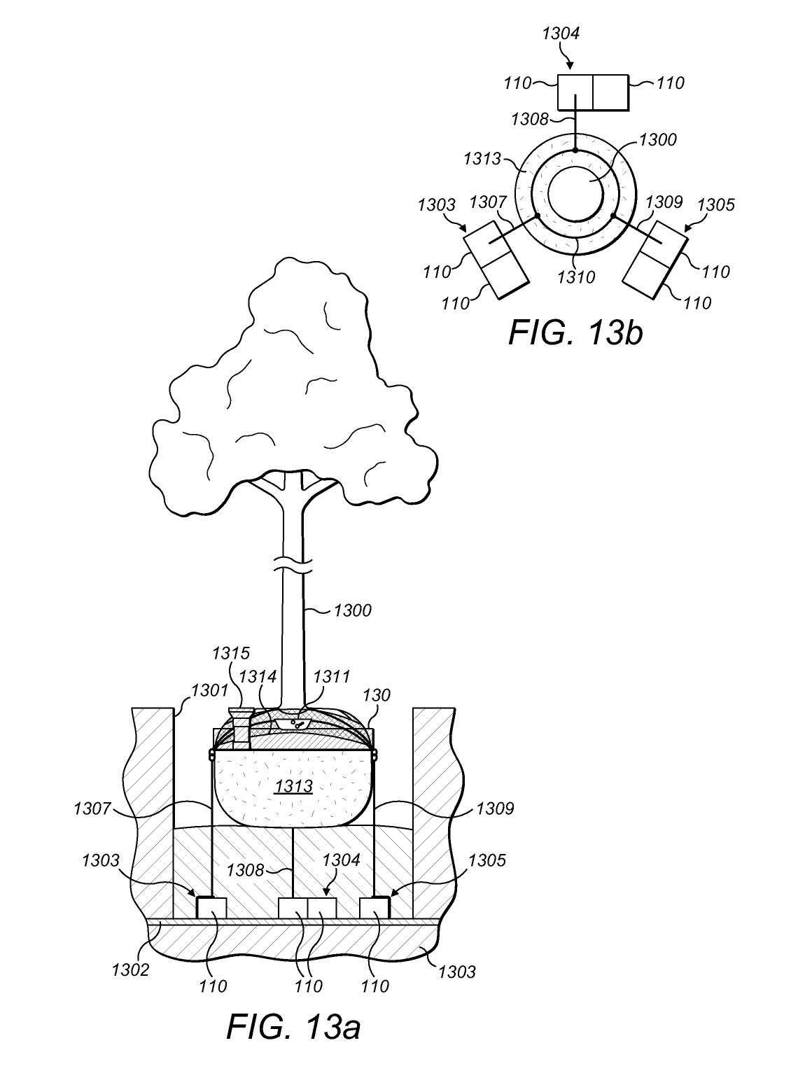

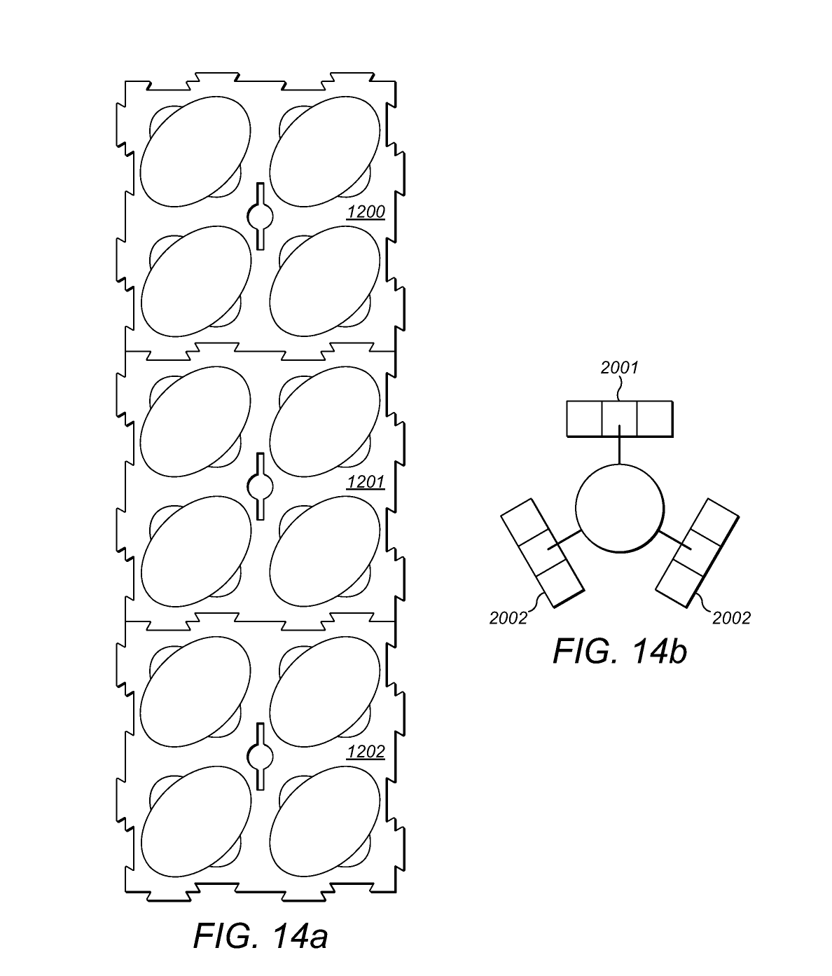

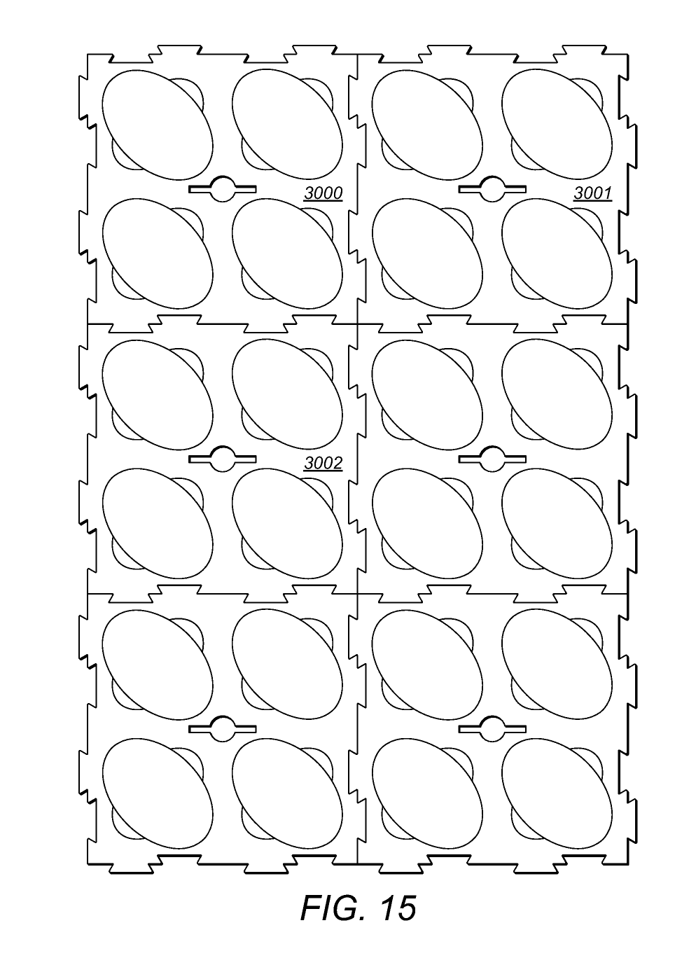

FIG. 13 is a schematic side view in part cross-section of a tree anchored by anchoring apparatus comprising anchor units as illustrated in FIGS. 2 to 11 arranged in a third arrangement and FIG. 13b is a schematic top plan view of the third arrangement of anchor units;

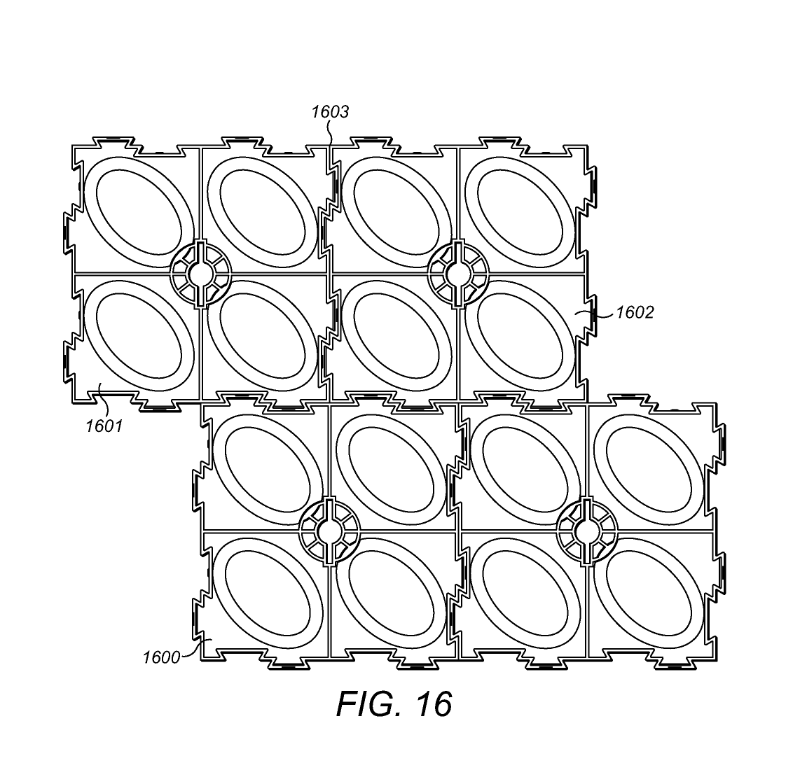

FIG. 14a is a plan view of an array of the anchor units of FIGS. 2 to 9, interconnected in a line;

FIG. 14b is a schematic top plan view of three of the arrays of FIG. 14a arranged around a tree, supporting the tree;

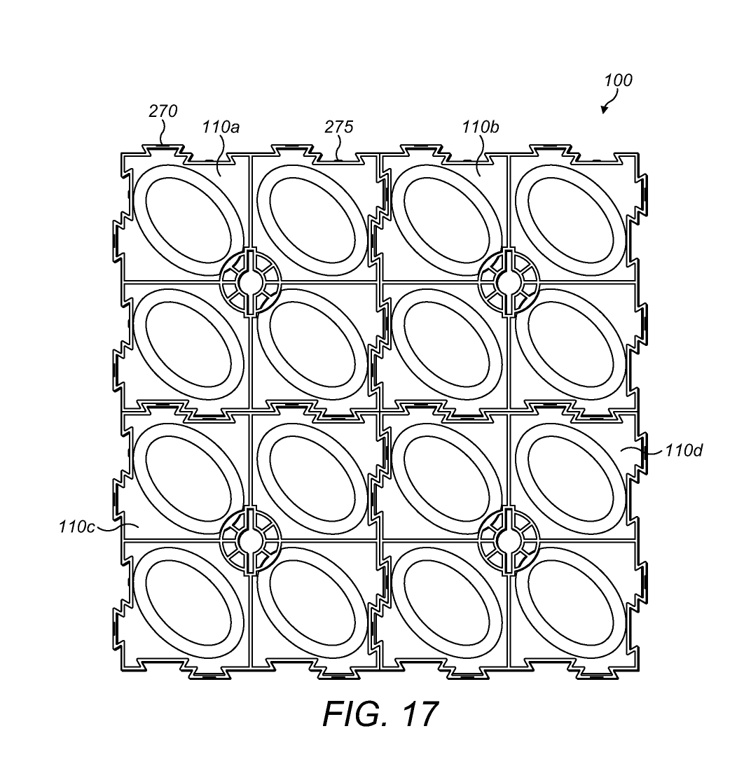

FIG. 15 depicts an array of the anchor units of FIGS. 2 to 9, interconnected to form a rectangular raft; and

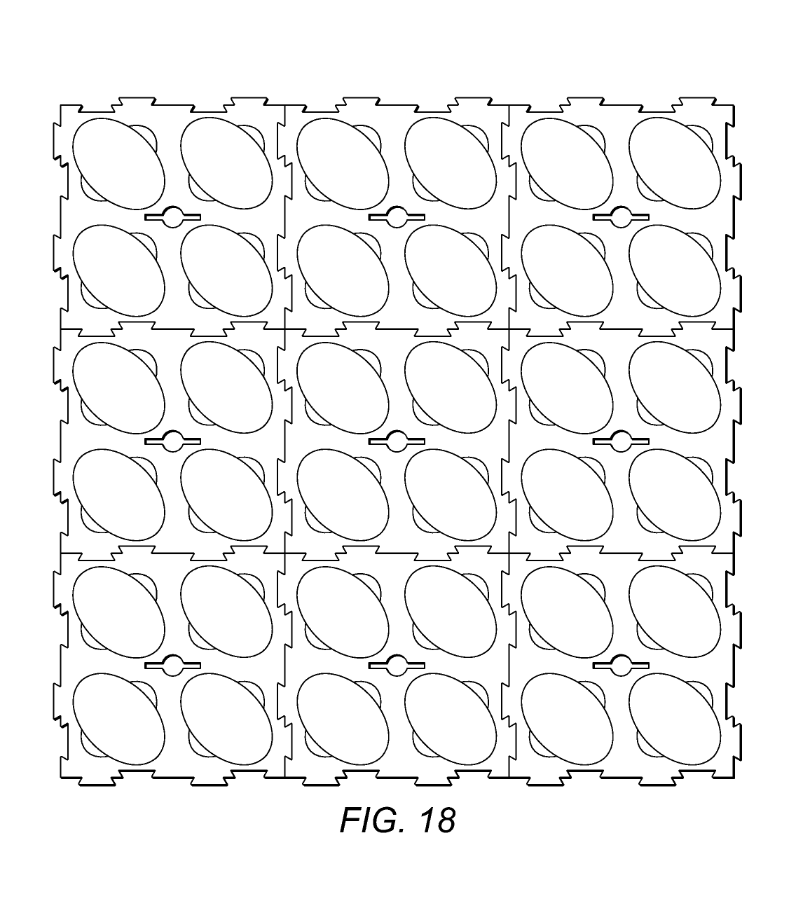

FIG. 16 depicts an array of the anchor units of FIGS. 2 to 9, interconnected with a one anchor unit bridging two other anchor units;

FIG. 17 depicts an array of the anchor units of FIGS. 2 to 9, interconnected to form a square raft;

FIG. 18 depicts an array of the anchor units of FIGS. 2 to 9, interconnected to form a square raft;

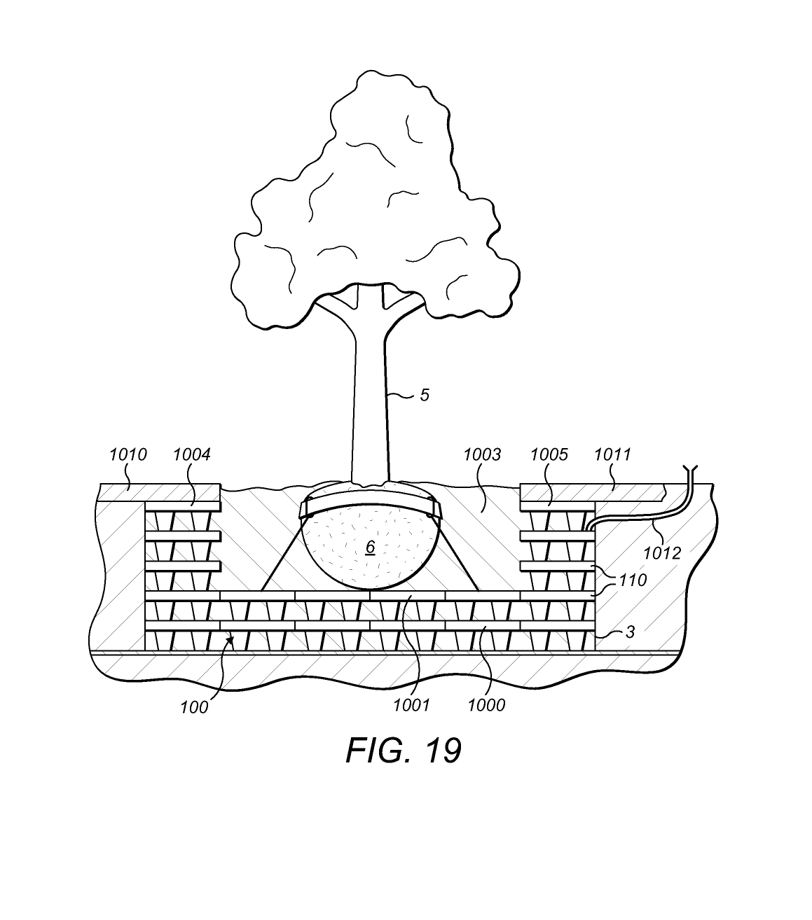

FIG. 19 is a diagram of a tree anchored by anchoring apparatus comprising the anchor units of FIGS. 2 to 9 arranged in a fourth arrangement;

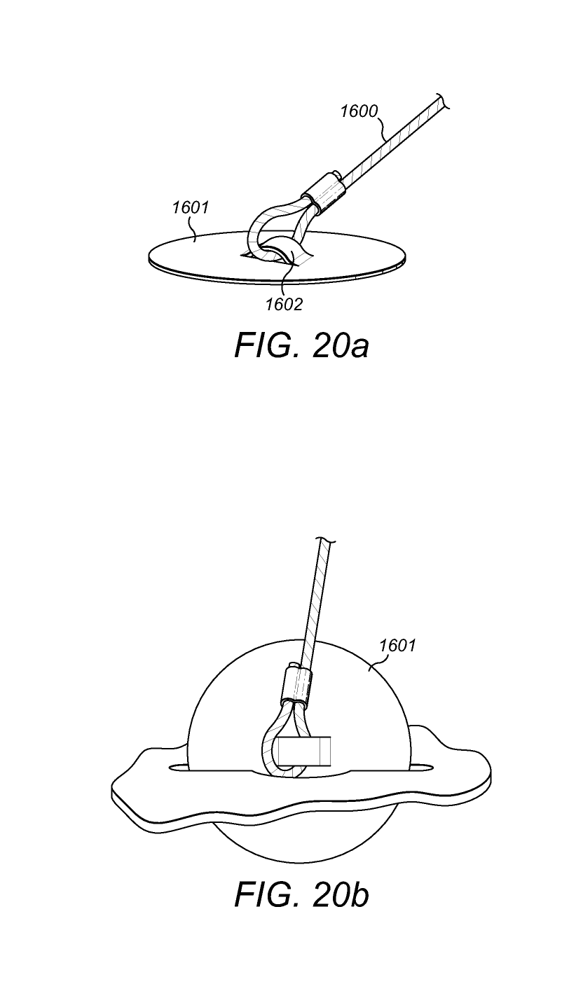

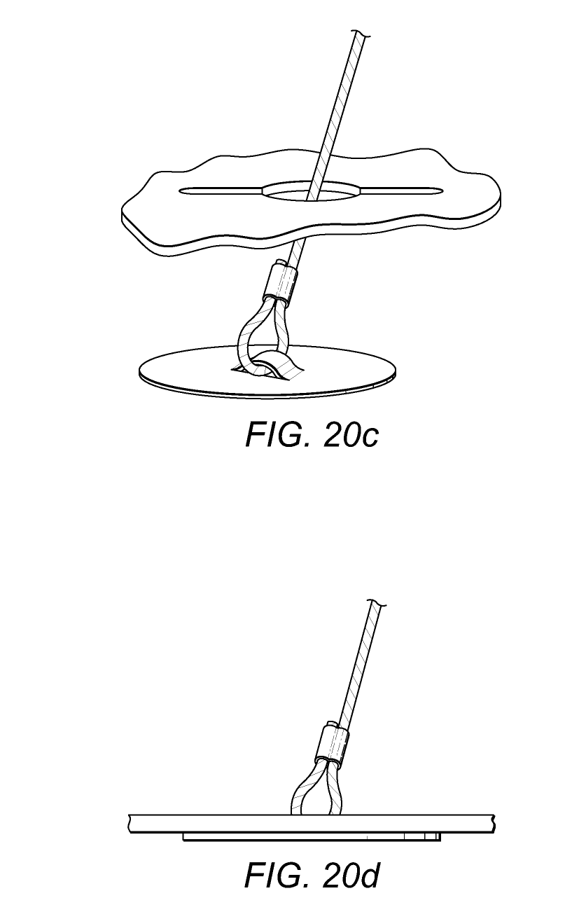

FIGS. 20a to 20c show a cable with an end fitting enabling the cable to be secured to an anchor point of an anchor unit and a method of securing the cable to the anchor point; and

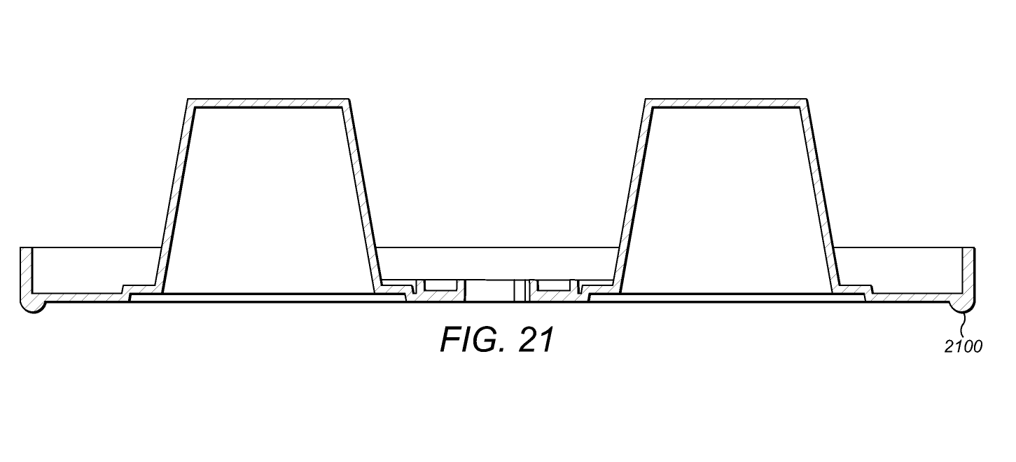

FIG. 21 shows a variant of the anchor unit of FIGS. 2 to 9.

The following describes preferred embodiments of the invention.

FIG. 1 shows a tree 5 secured in a pot 3 with only a shallow covering of soil 2. Since the pot rests upon a rooftop 7, it is not possible to secure the tree 5 to the rooftop itself, since it is not permitted to use penetrative fixings which would penetrate roof 7 and provide a passage for water.

The tree 5 has a root ball 6 and is anchored in place by tree anchoring apparatus comprising a cable or strap 10, 20, which is secured to tree anchoring apparatus 100.

Suitable means for strapping the root ball 6 of the tree 5 with a cable or strap 10, 20 and then tensioning the same with a suitable tensioner, may be found in WO 2010/146336.

The tree anchoring apparatus 100 is located in the base of the pot 3, and an overburden of soil 2 is supported by a support surface 140 provided by the apparatus 100. The soil also surrounds the root ball 6.

Unlike the weights used in the prior art method of anchoring a tree, the tree anchoring apparatus 100 of FIG. 1 is lightweight. Rather than relying on its mass to anchor the tree 5 in place, the tree anchoring apparatus 100 provides a relatively large upper surface area 140 supporting an overburden of soil 2, sufficient that the weight of the soil overburden anchors the tree rather than the weight of the tree anchoring apparatus 100 itself. Thus, the anchoring of the tree 5 in FIG. 1 does not require the transportation or handling of cumbersome heavy weights, such as railway sleepers kerb stones, path edging. Instead, a lightweight and easy to assemble tree anchoring apparatus 100 is arranged within the pot 3.

FIGS. 2 to 9 show a first embodiment of an anchor unit 110 for use in anchoring apparatus 100 according to the invention. As can be seen in these figures, the anchor unit 110 is formed to provide a planar upper surface 140 (see FIG. 2) for supporting an overburden of soil thereon. The anchoring unit is formed with four identical sections 101a, 101b, 101c, 101d. In the illustrated preferred embodiment, a plurality of cups 210a, 210b, 210c, 210d, extend downwardly from the upper surface, each cup 210a, 210b, 210c, 210d provided in the respective section 101a, 101b, 101c, 101d of the anchor unit 110. The anchor unit 110 is preferably formed from a single piece of material by a process such as injection moulding; the anchor unit can be formed from recycled plastics, HDPE and/or polycarbonate.

Each cup 210a, 210b, 210c, 210d has a substantially flat base 220a, 210b, 210c, 210d (see FIG. 3) and a side wall 230 extending from its base 220 to where the cup meets with a planar layer 102, the top of which provides the planar upper support surface 140.

Raised ribs 900 can be formed on the lower part of planar layer 240 between the cups 210 to enhance the rigidity of the tray 200, as seen in FIG. 9.

In the preferred embodiment each cup 210a, 210b, 210c, 210d has, in a plane perpendicular to the longitudinal axis of the cup 210a, 210b, 210c, 210d, a cross-sectional shape that is not axially symmetric. When a first anchor unit 100 is placed upon a second identical anchor unit in the same orientation, the cups 210a, 210b, 210c, 210d of the two units 100 will nest, with the upper surfaces 240 of the two units 100 relatively close together. In contrast, when the first unit 100 is placed upon a second identical unit 100 in a different orientation (e.g. when the unit is rotated through 90° or 270° with respect to the second unit), the first unit 100 will sit upon the second unit 201b such that the upper surfaces 240 are spaced apart by a larger distance. The illustrated cups 210a 210b, 210c, 210d of FIGS. 2 to 9 have cross-sections perpendicular to the longitudinal axis of the cups which are elliptical. The major axes of the cups 210a, 210b, 210c, 210d are parallel with each other.

It is preferable that each anchor unit has a square array of cups 210a, 210b, 210c, 210d (i.e. having the same number of cups 210 along its length as across its width).

In the illustrated preferred embodiment, a pair of recesses e.g. 105a, 105b are formed in the upper surface 240 extending radially outwardly from each cup, e.g. 210a. The pair of recesses 105a, 105b together form a seat, e.g. 225, arranged to receive the flat base 220 of another cup e.g. 210b, 210c, 210d. The seats 225 each have a shape matching the shape of the flat bases 220c of the cups e.g. 210c. In plan view, the geometric centre of the seat 225 coincides with the geometric centre of the cross-section of the cup 210. Thus, the flat bases e.g. 220c, 220d of the cups e.g. 210c, 210d may rest within the seats 225 of other anchor units. In this way, it is possible to stack units 110 of the preferred embodiment by alternating the orientation of neighbouring units 100.

Each anchor unit 110 is made moulded from lightweight, strong and rigid material. Preferably, the anchor unit would be moulded in a recycled plastic, from HDPE or from Polycarbonate.

A method of anchoring a tree comprises connecting together a plurality of anchor units in situ to form a layer at the bottom of a pot 3 or a pit dug into the ground (if a pot 3 is not required); see FIGS. 1 and 17.

The root ball 6 of the tree 5 can be placed onto tree anchoring apparatus 100 comprising a layer of interconnected anchor units 110, either directly, or after a layer of soil 2 has been deposited, as shown in FIG. 1. The soil 2 can act to raise the height of the tree 5 to a desirable level.

Alternatively, the tree anchoring apparatus 100 can comprise multiple layers of interlocked anchor units 110 as shown in FIG. 17, which can be used to alter the height of the tree 5, as described in more detail below.

Cables and/or straps 10, 20 are arranged on the top surface of the root ball 6 and surrounding the trunk of the tree 5. These cables or straps 10, 20 are attached to the tree anchoring apparatus 100 at anchor points 150 of the anchor units 110. Soil 2 is then deposited around the root ball 6 and on top of the layer(s) of interconnected anchor units.

The larger the soil supporting surface provided by the interconnected anchor units 110 of the tree anchoring apparatus 100, then the less likely are the interconnected anchor units are to be pulled through the soil by loading on the tree 5.

When an upward force is applied to interconnected anchor units 110 then the weight of an overburden of soil above the anchor units 110 prevents the anchor units from lifting. The interconnected anchor units share the loading among themselves.

It is necessary to compact the soil 2 around the root ball 6 to achieve a firm support for the root ball.

As can be seen in the FIGS. 1 and 17, the tree anchoring apparatus 100 is formed as a generally planar support surface in which are formed the plurality of cups 210a, 210b, 210c, 210d. When the anchor units 110 are interconnected then it is preferred that the areas of the open mouths of the cups is greater than the area of the surrounding planar surface. Advantageously, the cups 210a, 210b, 210c, 210d retain soil 2 in a manner which is advantageous to the interaction of the interlocked anchor units 110 with the soil. The cups also act to retain water near to the root ball 6 after watering of the tree 5, to irrigate the root ball 6. The roots of the tree 5 can grow down into the cups. The depths of the cups 210a, 210b, 210c, 210d also serves to provide the anchor units 110 with rigidity, i.e. a resistance to bending.

In preferred embodiments, the side wall 230 of each cup 110a, 110b, 110c, 110d is tapered, so that the cups 210a, 210b, 210c, 210d narrow towards their bases 120 (i.e. away from the open mouths of the cups). The angle of the side wall 230 determines the slope of the frustum of soil 2 overburden supported by the cups 210a, 210b, 210c, 210d. Preferably, the side wall 230 would be at an angle of 90° to 100°, e.g. 95°, to the longitudinal axis of the cup 210a, 210b, 210c, 210d, (which, in the first embodiment coincides with the axis of rotational symmetry of the cup). In other words, the side wall 230 would be at an angle of 95° to the vertical direction when the anchor unit 110 is laid on flat ground.

Advantageously, when an upward force is applied to an anchor unit 110 having tapered cups 210a, 210b, 210c, 210d, (such as that shown in FIG. 3) a larger volume of overburden of soil 2 acts to prevent movement of the tray 100 than if the anchor units 100 had a simple planar support surface for the overburden.

The cup portions 210a, 210b, 210c, 210d of the tray 100 of FIGS. 2 to 4 have an elliptical cross-section perpendicular to the longitudinal axis of the cup portion 110. However, any shape can be used, such as a circular cross-section, an hexagonal cross-section, or a rectangular cross-section.

FIG. 10 shows a plurality of anchor units 100a, 100b, 100c, 100d, stacked in a first arrangement. With each anchor unit aligned in a first orientation to its neighbours it is possible to stack a plurality of anchor units 100a, 100b, 100c, 100d in a nested fashion so that each cup 210a, 210b, 210c, 210d of one anchor unit sits within a corresponding cup 210a, 210b, 210c, 210d of another anchor unit. Therefore, the anchor units can be advantageously stacked in a compact form, as shown in FIG. 10, allowing easy storage and transportation.

FIG. 11 shows a plurality of anchor units 100 stacked in a second arrangement. As briefly mentioned above, and as shown in FIG. 17, it is sometimes preferred to raise the height of a tree 5 to be planted above the level of the base of a pot 3 or a pit in the ground that is intended to house the root ball 6. As can be seen in FIG. 11, by stacking the anchor units 110a, 110b, 110c, 110d in a second orientation relative to each other, it is possible to stack the anchor units 101a, 101b, 101c, 101d so that the base 120 of a cup 201a, 201b, 201c, 201d of a first anchor unit, e.g. 110a, is located in the recess 225 (see FIG. 2) of a second anchor unit e.g. 110b, with the upper support surfaces of the stacked anchor units 110a, 110b, 110c, 110d spaced apart by the cups e.g.; 210aI, 210aII, 210aIII, 210aIV. Therefore, the anchor units 110a, 110b, 110c, 110d can be advantageously stacked in a way which allows a root ball 6 to be supported thereon at a raised level as compared with the surface on which the stacked anchor units rest; see FIG. 17 in which a first layer 1000 of stacked anchor units 110a, 110b, 110c, 110d cover the bottom of pot or pit and a second layer 1001 of interlocked anchor units 110a, 110b, 110c, 110d are stacked on the first layer 1000 in the second orientation, supporting the root ball and the overburden of soil 1003.

Also shown in FIG. 17 are stacks 1004 and 1005 of anchor units 110 which extend alongside root ball 6 and in which the anchor units 110 are spaced apart since each anchor unit 110 is in the second orientation relative to the anchor unit 110 stacked thereon. The stack 1004 supports an edge of a paving slab 1010 and the stack 1005 supports an edge of a paving slab 1011. A conduit 1012 allows water to be supplied to the stacked anchor units for storage in the cups of the anchor units and to irrigate the tree 5.

For small trees such as tree 1200 in FIGS. 12a and 12b, the anchor units 110 can be used as illustrated in the Figures. In the FIG. 12a the tree 1200 is supported in a pit 1201 dug in a brownfield site. An impermeable membrane 1202 is spread across the site to overlay contaminated soil; only a part of the membrane 1202 is shown in the Figure. In the bottom of the pit 1201, above the membrane 1202, three individual anchor units 110, e.g. of the type described above, are used spread around the tree as can be seen in FIG. 12b, which is a schematic plan view from above (with soil removed). The arrangement is shown in a schematic side view in FIG. 12a. The units 110 have the advantage that they can be nested for transport and have the cups in their surfaces which each support a frusum of top soil 1204 thereabove, each cup giving rigidity to the anchor unit 110 and each cup acting as a water reservoir. Whist the anchor units 110 each have interlocking features on their edges, as described above, so that they have the flexibility of being used in other configurations, as described below, the interlocking features are not needed in the arrangement illustrated in FIGS. 12a and 12b and variants of the anchor units 110 could be provided without any interlocking features along the side edges, but otherwise identical to the anchor units 110 described above, for use in anchoring apparatus arranged as illustrated in FIGS. 12a and 12b. The three anchor units 110 would be supplied in a kit for each tree, the kit also comprising three wire tendons 1205, 1206, 1207 and a strap 1208 which encircles the tree and impinges a top surface of the root ball 1209. The tendons 1205, 1206, 1207 are tensioned by a strap tensioner 1210. An irrigation system, comprising a porous conduit 1211 and a funnel 1212 for delivery of water to the conduit can be included in the kit, as is illustrated in FIG. 12a.

For larger trees such as tree 1300 in FIGS. 13a and 13b, the anchor units 110 can be used as illustrated in the Figures. In the FIG. 13a the tree 1300 is planted in a pit 1301 dug in a brownfield site. A gas tight membrane, a part of which is shown as 1302 in FIG. 13a, covers the contaminated subsoil 1303. The pit 1301 is dug in topsoil overlaying the membrane 1302. At the bottom of the pit 1301 are arranged three pairs 1303, 1304, 1305, of anchor units 110; each pair 1303, 1304, 1305 of anchor units 110 comprising two anchor units 110 interlocked together to act as a single unit and to share the loading thereon. Soil 1306 is compacted above the pairs 1303, 1304, 1305 of anchor units 110 and each pair provides a soil supporting surface with twice the area of the individual units used in the arrangement of FIGS. 12a and 12b, thus the arrangement of FIGS. 13a, 13b is able to support greater loading than the arrangement of FIGS. 12a, 12b. Since each anchor unit 110 in the FIGS. 13a, 13b arrangement needs only to interlock with one other anchor unit, to form a pair, the interlocking features described above need be provided only on one side face of each anchor unit and not on all four faces, although providing the interlocking features on all four faces does provide flexibility of assembly as described below. The anchor units 110 will be provided as part of a kit comprising also comprising three wire tendons 1307, 1308 and 1309, a cable 1310, a cable tensioner 1311 and geotextile malting 1312. The malting 1312 is arranged on top of the root ball 1313 of the tree 1300. The cable 1310 is arranged on top of the malting 1312. The three tendons 1307, 1308, 1309 connect the pairs 1303, 1304, 1305 of anchor units 110 to the cable 1310. The tensioner 1311 is provided to tension the cable 1310 and thereby the tendons 1307, 1308, 1309. The kit can also comprise an irrigation system having a porous conduit 1314 and a funnel 1315 connected to the conduit to supply water to the conduit 1314.

The anchor units 110 can be used interconnected in a line of three as shown in FIG. 14a. If so used then they can be used as a straight replacement for the existing use of railways sleepers, kerb stones, paving edges. For example, a tree might require three sets 2000, 2001, 2002 of interconnected anchor units 110 spread around the tree as shown in FIG. 12b.

Alternatively a rectangular 3 by 2 array as shown in FIG. 15 might be used to cover the base of a pot or of a pit, or a larger surface 3 by 3 array as shown in FIG. 18 for a larger tree. Indeed the whole of the bottom of a pit or pot or planting area can be covered by an array of interlocked anchor units. The array could cover a large planting area for several trees, with flexibility of location provided by the fact that the anchor units each have an anchor point and so only selected ones of the anchor points can be used to suit the planting. An array of anchor units covering a planting area also provides an additionally useful barrier layer to prevent roots of the planted tree growing down below the barrier layer, e.g. to prevent damage to services such as water pipes or gas pipes or sewer pipes.

Multiple different arrays are possible and a square 2 by 2 array is shown in FIG. 17. It is also possible, as shown in FIG. 16, for a single anchor unit 1600 to be interlocked with two abutting anchor units 1601, 1602, spanning the interface 1603 between the two anchor units 1601, 1602. This may lead to more secure interlocking of the anchor units.

As shown in FIG. 17, an array of four anchor units 110a, 110b, 110c, 110d are arranged in a two by two grid to provide tree anchoring apparatus 100. The anchor units 110 of the preferred embodiment are interconnected using dovetail joints formed from interlocking pins 270, and tails 275, provided along each side face of the planar layers 102 of the anchor units, with the dovetail joints formed between adjacent units 100 by inserting the pins 270 in the tails 275. The pins 270 and tails 275 have matching trapezoidal shapes.

As can be seen from FIGS. 12a to 18, owing to the shape of the pin and tails, when the dovetail joints are formed between anchor units 110, then relative motion of one anchor unit 110 relative to the other(s) with which it is interconnected is prevented.

To further secure adjacent units 100 together niches and tabs 272, 277 are provided on and in the tails 275 and pins 270, as best shown in FIGS. 6 and 7. Niche 272 is provided in a face of a pin 270. Tab 277 is provided on a face of a tail 275, the tab 277 having a shape complementary to the niche 272.

As can be seen in FIG. 3, a channel 273 is provided in the face of pin for guiding the tab 271 to the niche 272.

Preferably, the channel 273 extends across the face of the pin 270 to terminate in openings on opposed the upper and lower surfaces of the pin 270.

Preferably, the channel 278 has a sloped or ramped surface 279 so that the depth of the channel decreases towards the mid point of the channel 278, i.e. towards the niche 272. Thus the tab 271 may be slid into the channel 278 from either side initially with relatively low resistance but with an increasing force in order to reach the niche 272, with some elastic deformation of the tab 277 and/or the surface of the channel 278 needed. This provides a reliable interlock.

As mentioned about and as shown in FIGS. 12a to 16 an array of anchor units 110 may be interlocked to form anchoring apparatus 100 of a desired size and shape. For instance FIG. 12a shows three anchor units connected in a line and this mimics the shape of a railway sleeper and provides an immediate substitute. However, the present invention allows the assembly of arrays of different sizes, e.g. to cover the whole of the base of a planting pot or planting area; this can be advantageous since the cups in the anchor unit act to capture water and store it for watering the tree anchored by the anchoring apparatus. Additionally the larger the surface area provided by the interlockable anchor units, the greater the force can be resisted by the anchoring apparatus. Once the anchor units are interlockable together they together form a rigid member and jointly react loading thereon.

FIG. 12a shows that the pins and tails located along only one edge of an anchor unit 1200 are interlocked with the pins and tails of a single abutting anchor unit 1201.

FIG. 13 shows that the pins and tails of two edges of an anchor unit 3000 interlock with a pin and tail of a first anchor unit 3001 and with a pin and tail of an edge of a second anchor unit 3002.

A preferred configuration of anchor point 250 for an anchor unit is shown in FIG. 2. The anchor point 250 comprises a slot 251 with a widened central circular operation. Reinforcing ribs 252 surround the anchor point on the rear side of the upper layer 240 (See FIG. 9). Preferably, the ribs extend radially from the widened section of the slot.

A strap or cable 1600 may be attached to the anchor point 250 using a disc 1601, as shown in FIGS. 18a to 18d. As shown in FIG. 18a, the disc 1601 comprises a plate 320 having an eye 1602 formed therein. The eye 1602 is central to the plate 320. The strap or cable 1600 is attached to the eye 1601 by a method as illustrated in FIGS. 18b to 18d. During assembly, the disc 1601 is oriented to pass through the slot of anchor point 250, as illustrated in FIG. 16b, the disc 1601 passing through the slot, with the eye 1602 and the end of the attached strap or cable passing through the widened central section of the slot. The disc 300 is then rotated as shown in FIG. 18c and then brought into abutment with the underside of the planar layer 102 as shown in FIG. 16d, with the strap or cable extending from the disc 1601 through the slot.

Preferably, the disc 1601 and eye 1602 are integrally formed, e.g. by stamping a planar member to form the eye 1602.

Raised ribs 900 can be formed on the lower part of planar layer 240 between the cups 210 to enhance the rigidity of the tray 200, as seen in FIG. 9.

In a modification of the anchor unit of FIGS. 2 to 9, illustrated in FIG. 20, a bead 5000 is provided which extends around the entire periphery of the top support surface 140. The rounded upper surface of the bead 5000 assists the guiding of the pins into the tails in the interlocking process, by removing abrupt edges from the anchor units.

Although reference is made throughout this specification and the claims to use of the anchoring apparatus for anchoring trees, the apparatus is of equal use for anchoring bushes and other plants which have a significant root ball.

1. A tree anchoring apparatus comprising:
a plurality of interlocking anchor units, each anchor unit having connection means allowing the anchor unit to be secured to at least one adjacent anchor unit;
an anchoring point provided for each anchor unit; and
a cable or strap securable to at least one of the anchoring points,
wherein the plurality of interlocking anchor units are transportable disengaged from one another and can be interlocked with each other in situ to jointly provide a surface for supporting an overburden of soil; and
wherein the cable or strap can be used to secure the interlocked anchor units to a root ball of a tree located there above, and
wherein each anchor unit has a periphery which is generally polygonal when viewed in a top plan view, and a plurality of side faces of the polygonal periphery are each provided with connection means to enable the anchor unit to be connected to a neighbouring anchor unit.

2. The tree anchoring apparatus as claimed in claim 1 wherein the connection means of each anchor unit allows the anchor units to be secured to a plurality of adjacent anchor units.

3. The tree anchoring apparatus as claimed in claim 1 wherein each anchor unit is provided with an anchoring point.

4. The tree anchoring apparatus as claimed in claim 3 wherein each anchoring point comprising a slot extending from an opening in the soil supporting surface through the anchor unit to an opening in an under surface of the anchor unit.

5. The tree anchoring apparatus as claimed in claim 1 wherein the anchor units are stackable for transport.

6. The tree anchoring apparatus as claimed in claim 5 wherein the anchor units are provided with co-operating features which allow a pair of anchor units to be stacked with their upper surfaces spaced apart by a first distance when the anchor units are stacked in a first orientation relative to each other and which allow the pair of anchor units to be stacked with their upper surfaces spaced apart by a second distance greater than the first distance when the anchor units are stacked in a second orientation relative to each other.

7. The tree anchoring apparatus as claimed in claim 5 wherein each anchor unit is provided with a planar layer providing a planar upper surface and at least one cup which has a mouth formed in the planar upper surface and which extends away from the upper surface with a side wall which extends from the planar layer to a base of the cup, and wherein when the pair of anchor units are stacked in the first orientation the cup(s) of one of the anchor units are inserted into the cup(s) of another anchor units located therebeneath.

8. The tree anchoring apparatus as claimed in claim 7 wherein the planar upper surface of each anchor unit is provided with at least one recess and when the pair of anchor units are stacked in the second orientation the then base(s) of the cup(s) of one anchor unit are inserted into the recess(es) of the other anchor unit.

9. (canceled)

10. The tree anchoring apparatus as claimed in claim 1 wherein each of the plurality of side faces is provided with connecting means comprising of at least one pin extending from the side face anchor units and a recess provided in the side face.

11. The tree anchoring of a first anchoring unit apparatus as claimed in claim 10 where the connecting means can form a dovetail joint with a second anchor unit and the pin is of trapezoidal shape and the recess is a matching trapezoidal recess.

12. The tree anchoring apparatus as claimed in claim 11 wherein one of the pin and the recess has a tab extending from a face thereof and the other of the pin and the recess has a niche formed in a face thereof.

13. The tree anchoring apparatus as claimed in claim 12 wherein the face with the niche has a ramped portion leading to the niche.

14. A tree anchoring kit comprising: the tree anchoring apparatus of claim 1, wherein the cable or strap is a plurality of cables or straps, with each cable or strap having a disc secured at an end thereof, the disc being insertable through the slot of an anchor unit in a first orientation and then rotatable to in a second orientation in which the disc can engage the upper surface of the anchor unit.

15. The tree anchoring kit comprising: the tree anchoring apparatus as claimed in claim 1, wherein the cable or strap is a plurality of cables or straps, each cable or strap being fastenable to one of the plurality of anchoring points provided by the plurality of anchor units.

16. A method of anchoring a tree comprising:
transporting to a planting site of the tree a plurality of anchor units, each anchor unit having connection means allowing the anchor unit to be secured to the remainder of the plurality of anchor units;
interlocking the plurality of anchor units together to provide a surface for supporting an overburden of soil;
securing a root ball of the tree to the plurality of anchor units interlocked using a cable or strap which is attached to one or more anchoring points provided by the interlocked plurality of anchor units; and
covering the root ball and the plurality of anchor units with soil, with the interlocked plurality of anchor units buried beneath the root ball and an overburden of soil on top of the interlocked plurality of anchor units, wherein
the plurality of anchor units are interlocked with each other such than an upward force applied to one anchor unit is transmitted to all of the remaining plurality of anchor units interlocked therewith.

17. A method as claimed in claim 16, wherein the plurality of anchor units when aligned in a first orientation relative to each are stackable with the soil supporting surfaces thereof spaced by a first distance and when aligned in a second orientation are stackable with the soil supporting surfaces thereof spaced by a second distance larger than the first distance, and
wherein the plurality of anchor units are all stacked for transportation in the first orientation relative to each other.

18. A method as claimed in claim 17 wherein the plurality of anchor units in which:
in situ are in a first plurality of the anchor units that are interlocked together to form a first layer, and
in situ are in a second plurality of the anchor units that are interlocked together to form a second layer, and
wherein the second plurality of interlocked anchor units are stacked on the first plurality of interlocked anchor units with the anchor units of the second plurality in the second orientation relative to the anchor units of the first plurality.

19. A method as claimed in claim 17 wherein
in situ some of the plurality of anchor units are interlocked to form a layer for supporting the overburden of soil and the root ball; and
in situ others of the plurality of anchor units are stacked alongside the root ball with each of the others of the plurality of anchor units in the second orientation relates to each anchor unit stacked thereon.

20. A method as claimed in claim 16 wherein
at least some of the plurality of anchor units used each have a cup formed therein, and wherein the cups are used to store water to irrigate the root ball of the anchor tree.

21-30. (canceled)
